(19) United States
(12) Patent Application Publication
(10) Pub. No.: US 2006/0170957 A1
(43) Pub. Date: Aug. 3, 2006

(54) System and method for automated control of computer printing features

(76) Inventors: Kim Niebling, Ballerup (DK); Rickie Songvist, Skovlunde (DK); Kenneth Lund, Valby (DK); Theis Olsen, Kastrup (DK)

Correspondence Address: PEDERSEN & COMPANY, PLLC, P.O. BOX 2666, BOISE, ID, 83701, US

(21) Appl. No.: 11/051,694

(22) Filed: Feb. 3, 2005

(51) Int. Cl. G06F 3/12

(52) U.S. Cl. 358/1.15

(57) ABSTRACT

The system and method automatically ensures the enforcement of specific computer printer or multifunction peripherals (MFPs) printing features according to predefined rules based on characteristics such as the originating computer user name, the originating computer application, or the originating file extension. A Client Service installed in the computer printers and MFP devices periodically retrieves the actual active rules from a central Server Service and then automatically applies these rules to preferably every incoming document to be printed.

Applicants hereby claim priority under 35 U.S.C. Section 120 based on the provisional application filed on Jan. 21, 2005, for System and Method for Automated Control of Computer Printing Features.

### BACKGROUND OF THE INVENTION

1. Field of the Invention

The invention relates to automated control of printing features of a document, such as but not limited to single- or double-sided printing, n-up mode, normal or draft mode, black-and-white or color mode, and media type selection (such as normal paper or bond paper). The system and method of automated control is embedded in computer printers or multifunction peripherals (MFPs) connected to a network such as a local area network (LAN) or a wide area network (WAN) ensuring the optimal economical use of the computer printers or MFP's and the network.

2. Related Art

The state of the art provides for manual control of the printing features through settings in the printer driver and in some cases directly in the software application which creates the document to be printed. Thus the state of the art provides various systems and methods of manual control of the printing features; however, the state of the art fails to provide an embedded method and system for automated control of printing features in networked computer printers and MFP devices.

Previously, the preferred way has been that users have been forced to remember to alter the printing feature settings manually in the printer engine when printing different kinds of documents to optimize the use of computer printers and MFP devices. An example being that everything printed from the printer engine serving the public Internet should be printed in black-and-white, double-sided, and in draft mode, thus saving both paper and printer/MFP consumables.

Aagesen, in International Publication Number WO 02/29541 A3, and United States Patent Application Publication Number 2003/0164977 A1, describes a method of controlling print operations via a print server. The method comprises the steps of routing a data stream representative of a document to be printed from a workstation (such as a personal computer) to the print server; causing the print server to determine from the data stream the type of document to be printed; causing the print server to determine a print format by reference to a first lookup table; and causing the print server to directly command the printer to print the document in the predetermined print format. This method requires that all workstations are set up to print through one or more dedicated print servers and that the system operators install, configure and maintain the look-up table on these print servers. Aagesen's method also means increased network load, as all documents that are printed utilize the network twice: once when sent from the workstation to the print server, and a second time when sent from the print server to the computer printer or MFP device.

It is cumbersome to manage a large network with several hundred or even thousands of computer printers and MFP devices by Aagesen's method. Most computer printers and MFP devices today are set up to receive print requests directly from a workstation without the intermediary step of routing the print request through the print server. MFP's are manufactured with hard drives that allow software to be installed on them. Printers, on the other hand, need to have a storage medium installed, such as a hard disk drive, flash DIMM, or memory flash card, to utilize software.

### SUMMARY OF THE INVENTION

The present invention allows printing features such as single- or double-sided printing, n-up mode (wherein multiple logical pages are printed on the same physical page), normal or draft mode (draft mode uses less toner or ink), black-and-white or color, and media type (type of paper), to be determined by characteristics of the print request such as, but not limited to, the source of the print request or the type of document to be printed. The print requests are sent directly from the workstation to the printer or MFP, which automatically changes the printing features of the document, without needing to go through a server. This is achieved by the printer making a request for rules from the server, and the server sending rules to the printer. When the printer receives a print request from a workstation, it compares the rules to the print request, and, if there is a match, modifies the print request before printing the document.

### BRIEF DESCRIPTION OF THE DRAWINGS

FIG. 1 is a conceptual overview of the preferred embodiment of the automated rule-based printing system.

FIG. 2 is a schematic overview of the preferred embodiment of the automated rule-based printing system.

FIG. 3 is a flow diagram of steps performed by one embodiment of the Server System upon a data package request from a Client Service, wherein the Server System is a sub-element in the preferred embodiment of the automated rule-based printing system.

FIG. 4 is a flow diagram of steps performed by one embodiment of the Client System, in which the Client Service (a software program installed on the Client System) communicates with the Server Service (a part of the Server System), both of which are sub-elements in the preferred embodiment of the automated rule-based printing system.

FIG. 5 is a flow diagram of the Client System, in which the Client Service extracts and applies rules from the data package and cooperates with the computer/workstation and Print Engine, all sub-elements in the preferred embodiment of the automated rule-based printing system.

FIG. 6 is a representative diagram of one embodiment of the request data package sent by Communication Network between the Client Service and Server Service, all sub-elements in the preferred embodiment of the automated rule-based printing system.

FIG. 7 is a representative diagram of one embodiment of the response data package sent by the Server Service to the Client Service through the Communication Network, all sub elements in the automated rule-based printing system.

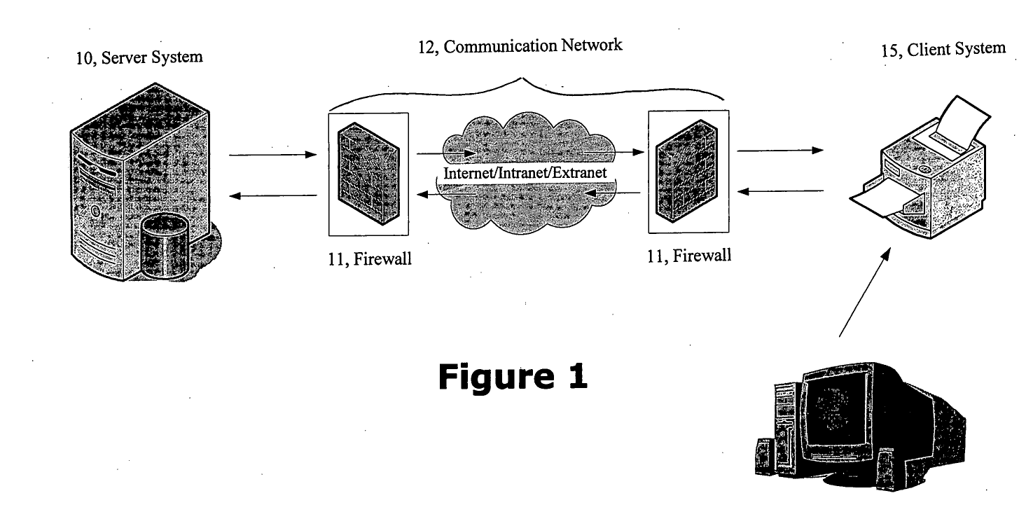

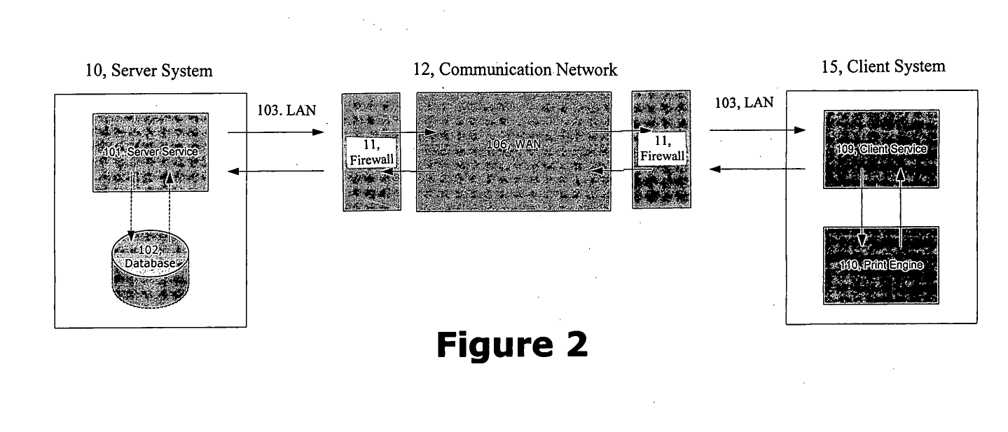

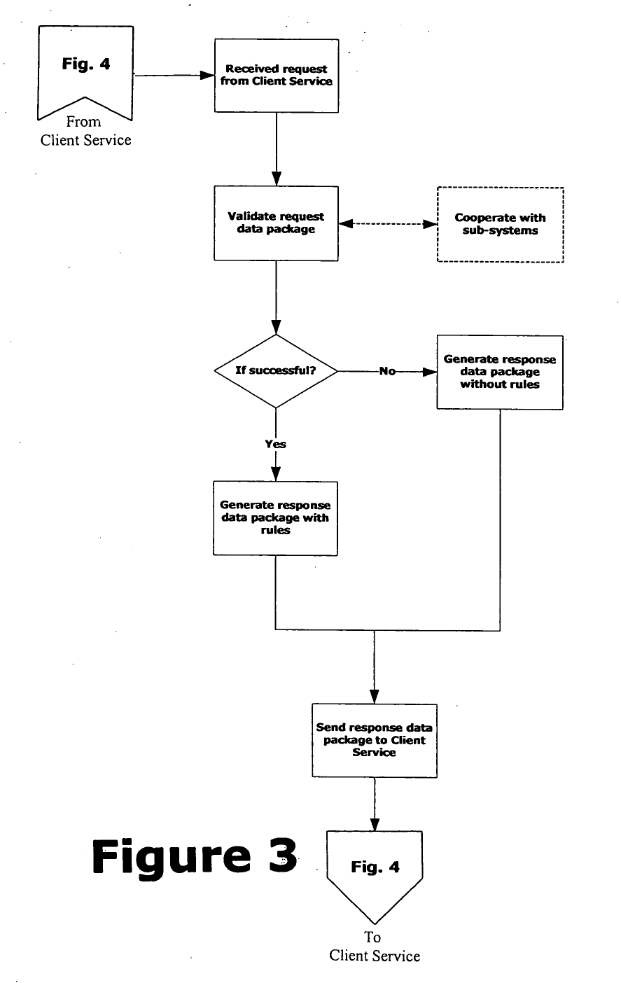

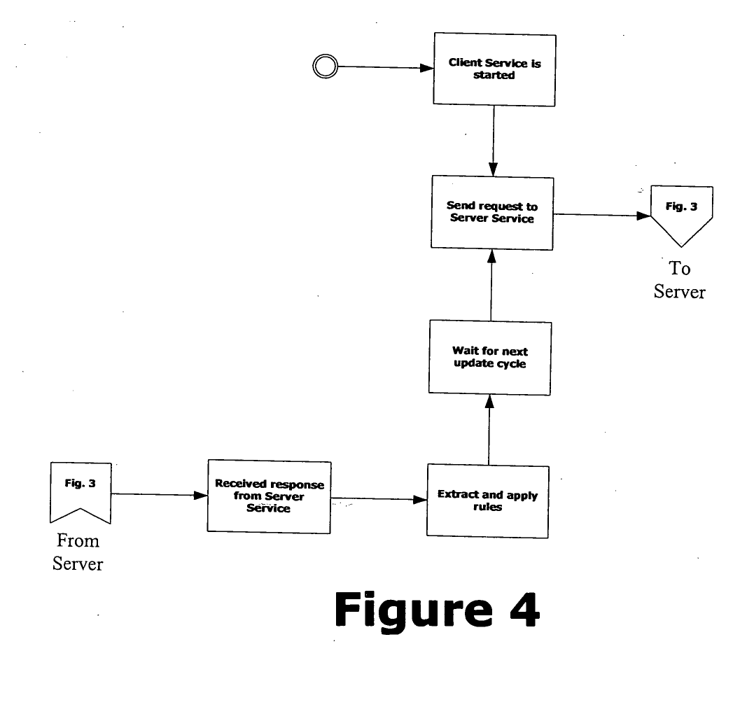

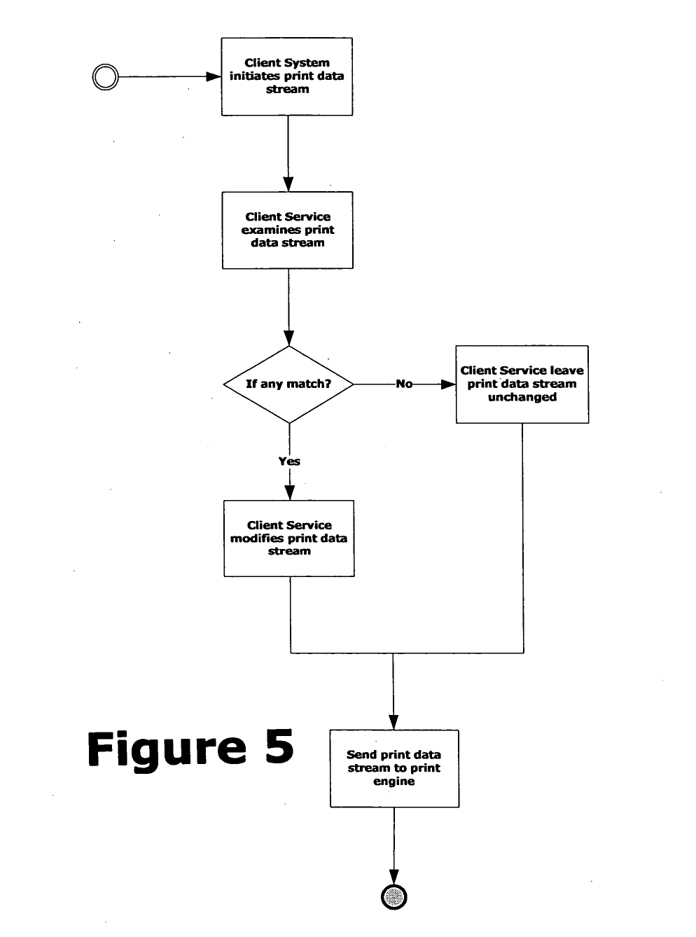

### DETAILED DESCRIPTION OF THE INVENTION

Referring to the Figures, there is shown one, but not the only, embodiment of the invented system and method.

The present invention provides a system and method enabling fully automated control of computer printer or MFP printing features through an automated rule-based printing system. The components of the preferred embodiment of the present invention are as follows. The Client System 15 (which is preferably attached to a network and can be either a computer printer or an MFP) comprises a Client Service 109, which is a software program installed onto the Client System 15, and a Print Engine 110, which is the hardware that actually prints documents. The Server System 10 comprises a Database 102 which stores information, and a Server Service 101, which can communicate with the Client Service 109, preferably through a Communication Network 12. The Server Service 101 is created by installing a software program onto the Server System 10. The Server System 10 is a centralized management and distribution system for allowing top-level employees such as print administrators to configure rules (behavior) for the printing environment and then upon request distribute them to the Client System 15. The Communication Network 12 may comprise several Local Area Networks (LAN's) 103 and Wide Area Networks (WAN's) 106 passing through the Internet, an Intranet, or Extranet, with attached firewalls 11, for example. Using a public network such as the Internet as the Communication Network 12 allows the Client Service 109 to communicate with the Server Service 101 running on a public accessible web server through firewalls, thus eliminating any need to alter any existing infrastructure. Further, use of the Internet allows the Rules 603 of each computer printer or MFP device to be controlled remotely, with no need for a Server System 10 at the same physical location as the Client System 15. Communication between the Client Service 109 and Server Service 101 through the Communication Network 12 is preferably carried on by standardized HTTP protocols that are capable of bypassing firewalls 11 without causing a security threat to existing systems and technology.

When the Client System 15 is turned on, and preferably periodically thereafter until it is shut down, the Client Service 109 requests rules from the Server Service 101 by sending a request data package 500 to the Server Service 101. The period is preferably determined by a print administrator, and could be every five minutes, once an hour, or once a day. Alternatively, the requests could be non-periodic, such as by determining the time interval between requests randomly. The request data package 500 is carried on over the Communication Network 12 by standardized protocols through LAN's 103, WAN's 106, and firewalls 11. The Client Service 109 initiates communication with the Server Service 101 (rather than the Server Service 101 initiating communication with the Client Service 109) because the Internet is preferably used for communication and the standard HTTP transport protocol, which most firewalls are open for, is used. Thus, the Client Service 109 knows the availability of and identity of the Server System 10, whereas the Server System 10 may not know whether a particular Client System 15 is available and needing updated rules, and the Client System 15 might not have a public IP address.

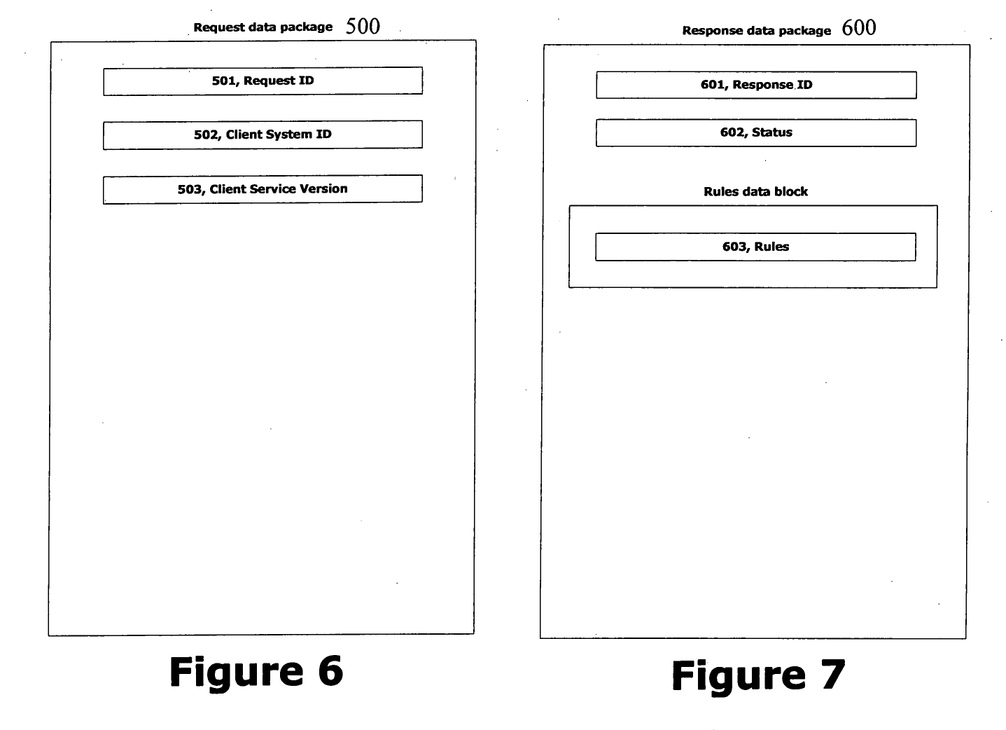

The request data package 500, which is preferably encrypted so that malicious attackers cannot sniff the request and make any sense of the data, preferably comprises a unique Request ID 501, a Client System ID 502, and a Client Service Version 503, as shown in FIG. 6. The Request ID 501 ensures that the request data package 500 is authentic and that requests cannot be replayed by accident or by malicious attackers. The Client System ID 502 is used to identify the Client System 109 and may be the printer serial number or other identifying alphanumeric series of characters. The Client Service Version 503 identifies the version number for the current Client Service 109 installed and is used by the Server Service 101 to send an appropriate response data package 600 that the Client Service 109 will be able to interpret.

When the Server Service 101, which can handle request data packages 500 from multiple Client Services 109, has received a request data package 500 from the Client Service 109, it first validates the authenticity of the request data package 500 in cooperation with the Database 102, based on the Request ID 501 and the Client System ID 502. The Request ID 501 must be in a specific format to be recognized by the Server Service 101. The Server Service 101 preferably maintains a list of every Request ID 501 that has been used. If the Request ID 501 has not been used before and the Request ID 501 is in the specific format recognized by the Server Service 101, then the request is successful and a positive response data package 600 with Rules 603 is sent to Client Service 109. Otherwise a negative response data package 600 without Rules 603 is sent to the Client Service 109. This prevents unauthorized use by recording or replaying of the request data package 500. The response data package is preferably sent to the Client Service 109 by standardized HTTP protocols through LAN's 103, WAN's 106, and firewalls 11. The response data package 600 is preferably encrypted so that malicious attackers will not be able to sniff -the response data package 600 and make any sense of the data, and includes headers describing the content (Rules 603), and the content itself.

By installing Rules 603 onto the Server System 10, a system operator is able to set up Rules 603 for all computer printer and MFP devices. The Rules 603 are based on the characteristics of the print request such as, but not limited to, the originating computer user name, the originating computer application name, or the originating file extension. The Rules 603 define the printing features that the different types of documents will be printed in, based on the characteristics of print request. Printing features include, but are not limited to, single- or double-sided printing, n-up mode (multiple logical pages will be printed on the same physical page), normal or draft mode (draft mode will reduce the use of computer printer or MFP device consumables such as toner or ink), black-and-white or color mode, and media type selection. The Rules 603 may also partly or completely block certain computers/workstations 108 from printing on certain computer printers or MFP devices. The system operator can set up the Rules 603 to completely prevent a user or a group of users from printing to certain devices, limit them to only being able to use these devices within certain hours, or simply prevent these users from printing in color mode on color capable devices.

A response data package 600 preferably contains a unique Response ID 601 and a Status 602. If the request was successful, then a rules data block containing Rules 603 will be added to the response data package 600. The Response ID 601 ensures authentication and that responses cannot be replayed by accident or by malicious attackers. The Status 602 is either positive or negative, and is used to inform the Client Service 109 about the status of the request. If the Status 602 contains a positive status, then the response data package 600 will contain Rules 603, and the Client Service 109 will extract the Rules 603 from a rules data block in the response data package 600. If the Status 102 contains a negative Status 602, then the package will not contain Rules 603 for the Client Service 109 to extract.

When the Client Service 109 receives the response date package 600, it authenticates the Response ID 601 and confirms a positive Status 602. If the Response ID 601 is authentic and the Status 602 is positive, then the Client Service 109 extracts the Rules 603 and instantly applies them to the Client System 15. The Client Service 109 then waits for the next update cycle.

When the Client System 15 receives a print request, referred to as an original print data stream, from the computer/workstation 108, the Client Service 109 immediately examines the original print data stream, and verifies if any Rules 603 have matching criteria in the original print data stream. If any Rules 603 do have matching criteria, such as originating computer name, originating file extension, or a combination thereof, in the original print data stream, then Client Service 109 modifies the original print data stream according to the Rules 603; otherwise the Client Service 109 leaves the original print data stream unmodified. Unless the Rules 603 prevent the computer or workstation from printing, the original or modified print data stream is sent to Print Engine 110, and the Print Engine responds by indicating that it is printing, and the print job is printed. The Server System 10 need not be utilized for receiving or sending printing jobs, and needs to be utilized only to update the Rules 603.

A further feature included in the preferred embodiment of the present invention is a “learning mode.” The Client Service 109 sends all relevant data for all print jobs printed to the Server Service 101. These data give an exact picture of the printing behavior including, but not limited to, originating application, originating computer user name, and file extension, and make it very simple for the system operator to define the optimal rules for his specific printing environment.

Another feature of the preferred embodiment of the present invention is the grouping of computer printers and MFP devices. This makes it very simple for the system operator to assign specific rules to either a single or to a group of computer printers and MFP devices.

The system described herein is a stand-alone system independent of the method of printing and is applicable to computer printer or MFP device drivers of any kind.

Although this invention has been described above with reference to particular means, materials, and embodiments, it is to be understood that the invention is not limited to these disclosed particulars, but extends instead to all equivalents within the scope of the following Claims.

I claim:

1. A system for determining a printing feature of a document comprising:
a client system which comprises a client service and a print engine;
a computer which is programmed to send original print data streams to the client system; and
a server system which is programmed to send data packages to the client service;
wherein the client service is programmed to send data package requests to the server system, receive data packages from the server system, extract rules from the data packages, receive original print data streams from the computer, apply the rules to the original print data streams, and send modified print data streams to the print engine.

2. The system of claim 1 wherein the server system is programmed to send data packages to the client service in response to data package requests from the client service.

3. The system of claim 2 wherein the data package requests and data packages are sent over a communication network.

4. The system of claim 3 wherein the communication network is an Internet.

5. The system of claim 2 wherein the client service is further programmed to send the data package requests to the server system periodically.

6. The system of claim 1 wherein the server system comprises:
a server service which is programmed to retrieve the data packages from a database and send the data packages to the client service in response to the data package requests from the client service; and
the database which is programmed to store the data packages.

7. The system of claim 2 wherein:
the data package request includes a request identification;
the server system is further programmed to include the rules in the data package only if the data package request is successfully validated based on the request identification.

8. The system of claim 2 wherein:
the data package request includes a request identification;
the server system is further programmed to include the rules in the data package only if the data package request is successfully validated by the server system based on the request identification; and
the data package includes a response identification.

9. The system of claim 2 wherein:
the data package request includes a request identification, client system identification, and a client service version;
the server system is further programmed to include rules in the data package only if the data package request is successfully validated based on the request identification; and
the data package includes a response identification and a status.

10. The system of claim 2 wherein the rules require modification of printing features of documents based on characteristics of the original print requests, the characteristics being selected from the group consisting of a name of the computer, an application name of the original print request, and a file extension of the original print request.

11. The system of claim 9 wherein the rules further prohibit modified print data streams from being sent to the print engine when the original print request was sent to the client system by a particular computer.

12. The system of claim 11 wherein the client service is further programmed to send the data package requests to the server system periodically.

13. A method for a client service to determine printing features comprising:
sending a data package request to a server system;
receiving a data package from the server system;
extracting rules from the data package;
receiving an original print data stream from a work station;
applying the rules to the original print data stream; and
sending a modified print data stream to a print engine.

14. The method of claim 13 further comprising sending data package requests to the server system periodically.

15. The method of claim 13 wherein the data package request and the data package are sent over a communication network.

16. The method of claim 13 wherein the data package request and the data package are sent over the Internet.

17. The method of claim 13 wherein:
the data package request includes a request identification feature selected from the group consisting of a request identification, a client system identification, and a client service version; and
the data package includes a data package identification feature selected from the group consisting of a response identification and a status.

18. The method of claim 13 wherein the rules determine printing features of the modified print data stream.

19. The method of claim 13 further comprising logging information about the modified print data stream.
